(19) United States
(12) Patent Application Publication
(10) Pub. No.: US 2003/0213926 A1
(43) Pub. Date: Nov. 20, 2003

(54) Digital/two stage valve actuator

(76) Inventor: John William Konopa, West Springfield, PA (US)

Correspondence Address: John W. Konopa, 7951 GRIFFEY ROAD, WEST SPRINGFIELD, PA, 16443, US

(21) Appl. No.: 10/144,352

(22) Filed: May 14, 2002

(51) Int. Cl. F16K 31/02

(52) U.S. Cl. 251/129.04

(57) ABSTRACT

This is a pneumatic actuator for a liquid delivery truck. The actuator can be added to an existing set stop valve without reconfiguring the piping. The same actuator can be used to upgrade several sizes of a rising stem valve. It provides the ability to open and close the valve as well as perform an adjustable low flow function. It works with existing relay logic from a cab mounted or meter mounted electronic preset. The actuator can be used with either an electric or pneumatic switch for setting the low flow position.

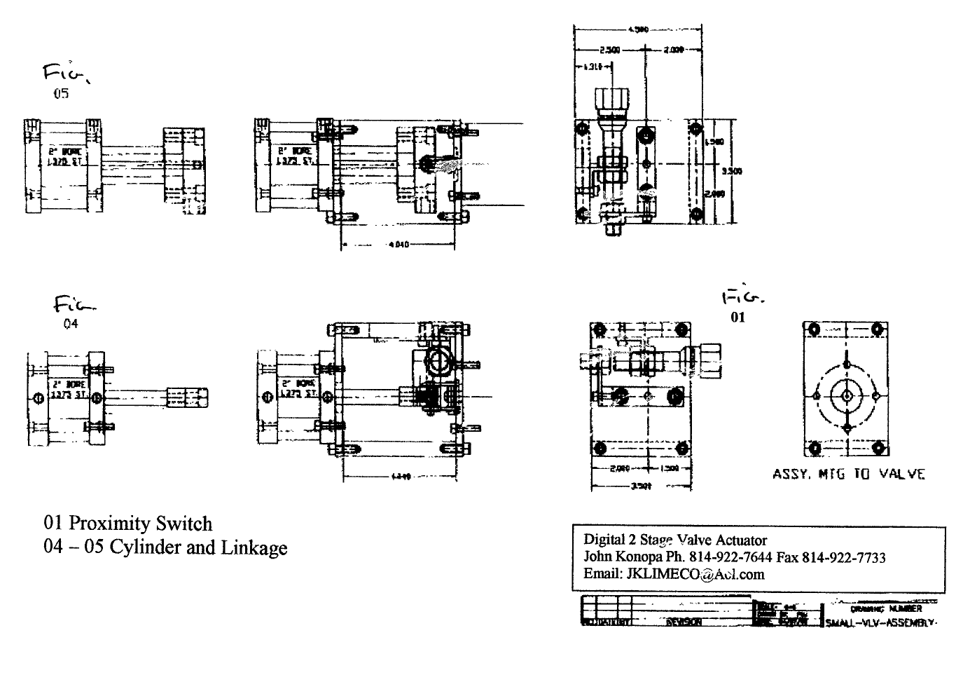

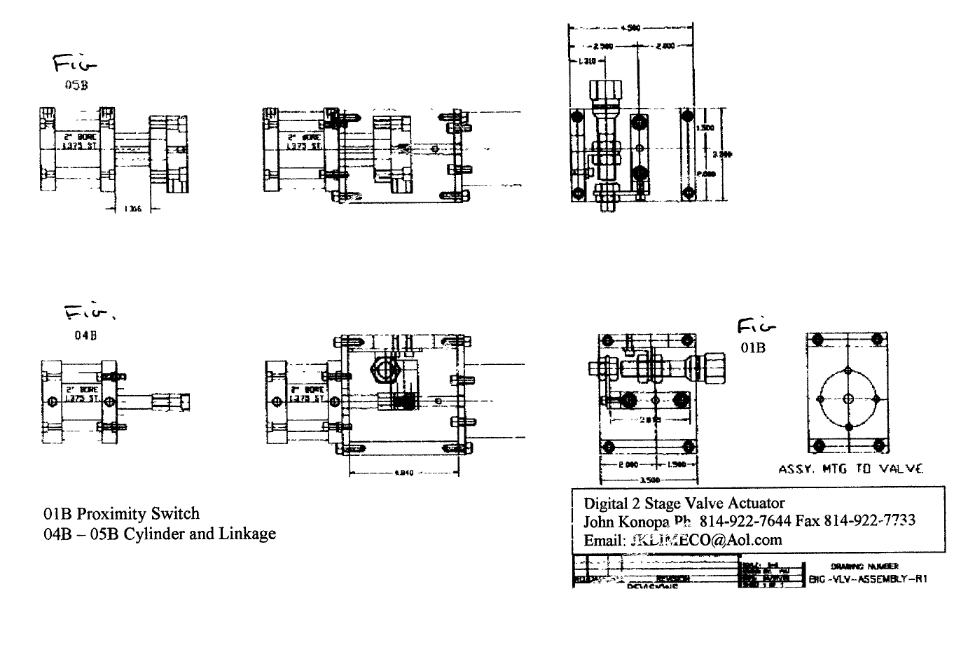

### SPECIFICATION

The Valve actuator can be driven by a Pneumatic or Hydraulic Source. The Actuator can provide the on/off function as well as a controlled midpoint flow.

The pneumatic/hydraulic actuator can be controlled by an electronic preset, PLC, cab mounted electronics, or meter mounted register head. Outputs from these devices will energize the solenoids or manifolds which control the operating sequence of the valve. Midrange flow can be obtained by using an electric or pneumatic proximity switch or by toggling Normally Open and Normally Closed Solenoids or Pneumatic Switches. The Valve Actuator allows the valve to close into a failsafe position at the loss of power. The Valve Actuator can be used with a remote control transmitter and receiver to provide remote shutdown capability. The valve actuator can be configured to operate rising stem valves or rotary valves in either direction.

What I claim as my invention is:

1. An electronically controlled Pneumatic/Hydraulic Valve actuator for Tank Truck Set Stop Valves which uses an electric or Pneumatic Proximity Switch and solenoids or spool valves to provide On/Off Control, an adjustable low flow rate set point or digital valve control.
